(19) United States
(12) Patent Application Publication
(10) Pub. No.: US 2025/0372593 A1
(43) Pub. Date: Dec. 4, 2025

(54) METHOD FOR COATING A SUBSTRATE

(71) Applicant: Alpha HPA Limited, Murarrie (AU)

(72) Inventors: Nikhil Aravindakshan, Cooper Plains (AU); Robert Williamson, Bulimba (AU)

(21) Appl. No.: 18/679,589

(22) Filed: May 31, 2024

(51) Int. Cl. H01M 4/04; H01M 4/02

(52) U.S. Cl. CPC H01M 4/0402; H01M 4/0471; H01M 2004/027

(57) ABSTRACT

A method for producing a coated substrate is described that includes forming an aluminium oxide hydroxide slurry by simultaneously feeding streams of an aluminium nitrate solution and a basic solution, such as an ammonia solution, into a liquid over a reaction period, while maintaining an elevated temperature and a controlled pH; allowing a substrate to contact the slurry to thereby form an aluminium oxide hydroxide coating on the substrate; and separating the coated substrate from the liquid.

### CROSS-REFERENCE TO RELATED APPLICATION

This application is related to co-pending Australian Patent Application No. XXXXXXX, filed May 31, 2024, entitled “A METHOD FOR COATING A SUBSTRATE,” (Attorney Docket No. 100701-2010) the contents of which being incorporated by reference in their entirety herein.

### TECHNICAL FIELD

The present disclosure relates to a method for producing a coated substate. The substate can be an anode. The coating can be an aluminium oxide hydroxide-coating.

### BACKGROUND

Lithium-ion batteries have become the backbone of modern technology, powering everything from smartphones to electric vehicles. However, their performance and safety have always been areas of concern.

Aluminium oxide, or alumina, has been found to improve the heat resistance and electrochemical performance of lithium batteries. Aluminium oxide coating on anodes can lead to improved cycling retention and safety performance. Applying an aluminium oxide coating to the anode can serve as a passivation layer that forms a stable SEI during the first charging cycle. Further, aluminium oxide-coated anodes can enhance the fast-charging capacity of lithium-ion batteries.

A commonly used surface aluminium oxide coating method is atomic layer deposition. Atomic layer deposition can be used to produce conformal coating layers and has a high degree of control over the thickness of the layers. However, atomic layer deposition is expensive and uses specialised equipment. It is also not as effective when coating substates with irregular surfaces or irregular-shaped form factors. Wet-chemistry processes have also been used to coat battery components, and while they are simpler and cheaper than atomic layer deposition, coating quality control can be poor with non-uniform and incomplete coatings formed. In addition, wet chemistry methods require a solution environment during coating, which produces waste liquid and requires filtering and additional drying or heating steps which increases cost.

There exists a need for an improved method for producing an aluminium oxide hydroxide-coated substrate that may be cheaper and/or more reliable than existing processes.

### BRIEF SUMMARY

In a first aspect, there is provided a method for producing a coated substrate, the method comprising:
forming an aluminium oxide hydroxide slurry by simultaneously feeding streams of an aluminium nitrate solution and a basic solution, such as an ammonia solution, into a liquid over a reaction period, while maintaining an elevated temperature and a controlled pH;
allowing a substrate to contact the slurry to thereby form an aluminium oxide hydroxide coating on the substrate;
separating the coated substrate from the liquid.

Advantageously, the method according to embodiments may produce a high purity aluminium oxide hydroxide coating. Further, the method according to embodiments of the disclosure may enable selective control of the degree of hydration of the aluminium oxide hydroxide coating and improved control over the thickness of the coating. The method according to embodiments of the disclosure may provide improved coating across complex surfaces and shapes. In addition, the aluminium oxide hydroxide-coated substrates may reduce thermal runaway and thermal runaway propagation in battery cells and systems. Further, the aluminium oxide hydroxide-coated substrates may have reduced risk of corrosion.

The substate can be planar. By planar it is meant that the substrate is not particulate and instead has planar surfaces. The planar surfaces can be flat. The planar surfaces can be undulating. There can be more than one planar surface such as on the face of a 3 dimensional object. The 3 dimensional object can be a sphere, a cube or other cuboidal shape. The coating can be on the outside of the substrate. The coating can be on the inside surface of the substrate. The coating on the substrate can be only on the outside surface(s) of the substrate. The coating on the substrate can be only on the inside surface(s) of the substrate.

The substrate may be any surface. In an embodiment, the substrate is an active material suitable for use as an electrode in a battery. Generally, the substrate may have a suitable electron conductivity and capacity for use in a lithium-ion battery. In some embodiments, the substrate is an electrode for use in an electrochemical cell. In embodiments where the electrode is a metal electrode, such electrode may, for example, be formed of nickel, cobalt, iron, silver, titanium, stainless steel, or alloys of any of these metals. Alternatively, the electrode may be a ceramic electrode, or a composite of a metal and ceramic electrode.

The substrate can be a particulate material. In an embodiment, the substrate may be a particulate material comprising one or more of silicon powder, graphite powder, and a metal oxide. In embodiments where the substrate is a particulate material, the substrate can be suspended in the liquid. The liquid can be deionised water. The aluminium nitrate solution and ammonia solution can be fed into the deionised water. The particulate material can be at least one inert material that is suspended in the liquid to form a suspension. The particulate material may be used as a seeding material to induce and control crystallisation of the slurry.

The suspension may comprise at least about 5, 7, 10, 12, 15, 17, or 20 wt % solids.

The substrate can be a solid material having flat surfaces. The flat surfaces can be e.g. the surfaces of a plate. The flat surfaces can be smooth. The flat surfaces can have undulations. The substrate can have any solid 3 dimensional shape such as a sphere or a cube. There can be more than one substrate in the liquid.

Typically, the liquid is non-reactive with the substrate. The liquid may be ultra-pure water, demineralised water, deionised water, or the like. Any suitable liquid may be used to suspend the particulate substrate and prepare the suspension.

The substrate may be added to the liquid. The liquid can be added to the substrate. The substrate can be in the liquid prior to the reaction period. The substrate can be added to the liquid during the reaction period. The substrate can be added to the liquid after the reaction period.

In some embodiments, the reaction vessel is heated while the substrate is added to or is in the liquid.

In an embodiment, the surface(s) of the substrate is/are pre-treated before the reaction period. The pre-treatment can be to provide an active surface for reaction. The pre-treatment can include a first step to remove residual organics such as fingerprints or any other passive organic contamination. The first step can involve a solvent that dissolves organics such as iso-propyl alcohol. Following the first step, or alternative to it, the substrate can be treated in an acid or an alkaline solution to change the chemical nature of the surface. The substrate can be immersed in an acid bath. The acid can be nitric acid or similar. Alternatively, or in addition, the substrate can be immersed in an alkaline bath. The alkaline can be ammonia or similar. The pre-treatment may also include one or more heating steps to activate the surface(s) of the substrate.

In an embodiment, streams of an aluminium nitrate solution and a basic solution such as an ammonia solution are dosed into the liquid.

A slurry of aluminium oxide hydroxide can be formed by the reaction of the aluminium nitrate and ammonia. The coating can be formed on the substrate when the slurry crystallises on the substrate. The streams of aluminium nitrate solution and basic solution such as ammonia solution can be dosed substantially simultaneously.

The aluminium nitrate solution may be any suitable concentration. Typically, the concentration of the aluminium nitrate solution may be about 2 g/L to about 20 g/L, or about 5 g/L to about 15 g/L. In some embodiments, the concentration of the aluminium nitrate solution may be about 10 g/L. In embodiments, the aluminium nitrate may be a high purity aluminium nitrate, such as >99.999% aluminium nitrate.

The concentration of aluminium nitrate is not limited other than that the pH of the aluminium nitrate should be adjustable with the pH adjuster. With this in mind, the concentration need not be too high in the range.

The basic solution can be any solution that allows for pH modification or adjustment as the aluminium nitrate is added to solution. In an embodiment, the basic solution is an ammonia solution. The ammonia solution may be any suitable concentration. Typically, the concentration of the ammonia solution may be about 0.1 to about 1.5 wt % ammonia, such as 0.2 to about 1 wt %, such as 0.5 to about 0.8 wt %. In some embodiments, the concentration of the ammonia solution may be about 0.2, 0.5, 0.8, 1, 1.2, 1.5 or 2 wt %. However, the concentration is not limited to this and it should be understood that less of the solution will be required the higher the concentration.

In an embodiment, the basic solution comprises urea. An advantage of ammonia over urea may be that there are less impurities. The purer the starting materials, the better the resultant coating on the substrate.

The aluminium nitrate solution and ammonia solution may be dosed at any suitable rate. Generally, the dosing rate and the time period over which the aluminium nitrate solution and the ammonia solution are dosed is sufficient to enable the formation and crystallisation of aluminium oxide hydroxide on the substrate while minimising the precipitation of impurities and/or entrainment of contaminated liquid. In one or all embodiments, the aluminium nitrate is dosed at a rate of at least or at most about 1.8, 2.3 or 2.5 mL/minute. In one or all embodiments, the ammonia is dosed at a rate of at least or at most about 1.4, 1.6 or 1.8 mL/minute. It should be understood that the dose rate my change according to the concertation of the solution where more concentrated solutions may require a slower dose rate.

The reaction period is the time in which the aluminium nitrate is simultaneously added with the pH modifying basic solution. In embodiments, the reaction period may be at least or at most about 1, 2, 3, 4, or 5 hours.

During the reaction period, the temperature can be elevated to a temperature in the range of from about 40, 50, 60 or 70° C. to about 85, 90, 100 or 105° C. In an embodiment, the temperature is about 80° C. during the reaction period.

In embodiments, the dose rate of the basic solution may be adjusted so as to maintain the pH of the slurry at about 4 to about 6 such as about 4.5 to about 5.5, such as about 4.9 to 5.1 during the reaction period. Where the temperature of the reaction is about 80° C., the pH may be adjusted to be in the range of about 4.5 to 5. If the temperature is cooler, for example about 50° C., the pH may need to increase to about 6.5 to 7 to see the same coating formation. The skilled person can adjust the parameters to prepare the coating.

In some embodiments, the pH of the liquid is adjusted during the reaction period to provide an aluminium oxide hydroxide monohydrate coating. In other embodiments, the pH of the liquid is adjusted to provide an aluminium oxide hydroxide trihydrate coating. In embodiments, the coating is aluminium oxide hydroxide monohydrate. In other embodiments, the coating is aluminium oxide hydroxide trihydrate. The water in the coating can be driven off by the subsequent heating steps. While the monohydrate or the trihydrate can be prepared, it may be that less water is desirable since in some applications, the presence of water can be deleterious to commercial operation.

The skilled person will appreciate, based on the teachings herein, that the starting concentrations of the aluminium nitrate and basic solutions, the reaction time, the temperature, may require adjustment according to the unique properties of the surface(s) of the substrate to be coated. Ultimately, the goal is a uniform coating of the aluminium oxide hydroxide coating over the surface(s) of the substate. By uniform coating it is meant that in an SEM image, visually inspected over about 1 micron×1 micron there is a uniform distribution of the aluminium oxide hydroxide coating. If the coating is not uniform, the concentration of the ammonia may need to be increased and the experiment repeated, as taught herein.

In embodiments where there is a uniform aluminium oxide hydroxide coating, the substrate may have a uniform coating at about 0.1 wt % to about 1.0 wt % aluminium oxide hydroxide, or at about 0.25 wt % to about 0.75 wt % aluminium oxide hydroxide. In some embodiments, the substrate may have a uniform coating at about 0.5 wt % aluminium oxide hydroxide.

The concentration of aluminium oxide hydroxide formed in the slurry will vary depending on many factors, including the concentration of the feedstock materials (e.g. aluminium nitrate solution, ammonia solution) and the volume of liquid in which the reactants are added. Generally, the concentration of the slurry is chosen to achieve a target coating level of the substrate. Increasing the concentration of aluminium oxide hydroxide formed in the slurry may increase the thickness of the coating on substrate. Conversely, reducing the concentration decreases the thickness of the coating.

The substrate is coated by the material of the slurry. The coating can be allowed to form in situ. An advantage of the coating forming in situ is that any difficult to access areas can be wet by the liquid and coated by the crystals. Generally, the reaction volume is sufficient to enable the crystallisation of coating on a desired portion of the substrate. In some embodiments, a portion of the substrate is immersed in the slurry, thereby only this portion is coated. In other embodiments, substantially all of the substrate is immersed in the slurry, thereby substantially all of the substrate is coated. In one or all embodiments, the reaction can be undertaken in a vessel where the walls of the substrate are intended to be coated. The resultant coating will form on the inside walls of the vessel.

After the reaction period, i.e. the aluminium nitrate has been completely dosed and the reaction phase ends, the slurry is allowed to age for a period of time in order to increase crystal growth and degree of crystallinity on the substrate. The ageing period may be at least about or at most about 10, 20 30 minutes or shorter or longer in duration from the end of the reaction period. During the ageing period the slurry may be stirred. While stirring may be advantageous, it may also not be present. Without wishing to be bound by hypothesis, it might be that stirring has an adverse effect on coating formation by creating chaos in the crystal formation. Accordingly, in some embodiments, there is no stirring during aging.

The slurry can be maintained at a temperature of about 40° C. to about 90° C. such as 50 or 60° C. to about 100° C. after the reaction period. In an embodiment, the liquid is maintained at a temperature of about 80° C.

The slurry can be maintained at a pH of about 5.5 to about 6.5 after the reaction period and prior to the slurry being prepared for filtration. In an embodiment, the slurry is maintained at pH of about 6.0. To adjust the pH the ammonia solution can be dosed into the liquid to change the pH. The pH can be controlled to the desired level for at least or at most about 15, 20 or 30 minutes.

In some embodiments, the slurry may be cooled after aging. The cooling can be to a temperature of about 40, 50 or 60° C. Once cooled the substrate can be separated from the spent liquor. Where the substrate is a metal plate or other solid shape, the substrate can be removed from the liquid. Alternatively, the liquid can be poured off the substrate.

Where the substrate is a particulate material, the slurry of coated substrate may be separated using any suitable technique known in the art. Generally, the separation technique may be sufficient to separate the coated substrate from the spent liquor. For instance, the separation technique may include gravity settling clarifiers, sedimentation, decanting, centrifugation, filtration, or the like. The aluminium-hydroxide-coated substrate may be separated from the spent liquor using vacuum filtration.

The spent liquor may comprise ammonium nitrate. The spent liquor may be recycled. The recycling may be for use in bulk explosive applications, or as a fertiliser.

The coated substrate may be washed to separate the coated substrate from impurities. The coated substrate may be washed with any suitable wash liquid. Generally, the wash liquid may be sufficient to redissolve soluble contaminants or the like from the coated substrate. The wash liquid may be sufficient to also displace the entrained contaminated liquid and replace with the less-contaminated wash liquid.

The wash liquid may be ultra-pure water, demineralised water, deionised water, or the like.

The washed coated substrate may undergo a drying step. Depending on the temperatures in the drying step, the resultant coated substrate will be dried, heated, decomposed and/or calcined. If the coated substrate is dried without calcining, the coated substrate can be an aluminium oxide hydroxide. If the coated substrate is also calcined, the product can be an aluminium oxide.

In some embodiments, the coated substrate is dried at a temperature of at least about 250, 280 or 300° C. The drying can be for about 4, 6, 8 or 12 hours after separation from the spent liquor.

In some embodiments, the coated substrate may be calcined under reducing conditions. The calcination can be to decompose an aluminium oxide hydroxide-coated substrate to an aluminium oxide-coated substrate. The aluminium oxide hydroxide-coated substrate may be heated at any temperature and for any length of time that results in calcination of the material. The term “calcining” means a high temperature heating process whereby a mineral-containing material is converted to its oxide form. It is also commonly referred to as ignition, heating, decomposition, pyrolysis or hydro-pyrolysis. As an example only, the calcination temperature can be between about 400° C. to 1,100° C., such as between about 500° C. to 1,000° C., or between about 600° C. to 900° C.

Calcination maybe undertaken in any suitable atmosphere, for example it may be any one of an inert atmosphere (such as a nitrogen gas and an argon gas), an oxidising atmosphere (such as an air atmosphere), or a reducing atmosphere (such as a hydrogen atmosphere). In some embodiments the coated substrate is calcined under a nitrogen atmosphere.

In embodiments, the coated substrate is calcined at a temperature of about 600° C. to 900° C. with a ramp rate of 2° C. per minute. The substrate is held at a temperature of 900° C. for about an hour and then cooled under a nitrogen atmosphere with a cooling rate of 2° C. per minute.

In embodiments, there is provided a coated substrate produced according to the method of the disclosure. The coating can be adhered to the substate by chemical or other bonds. The coating is optionally not removable from the substrate with hard rubbing. Some coating may shed from the substate when first handled. Optionally, the coating is uniform and smooth. The uniformity relates to the distribution of the coating over the surface. The surface that was intended to be coated can be at least about 95, 98, 99 or 100% coated with the coating. In particles, at least about 95, 98, 99 or 100% of available surface. The thickness of the coating can be relatively uniform across the coated surfaces. The thickness can deviate only by about 5, 10, 15 or 20% over the coated surface.

In embodiments, there is provided use of coated substrate produced according to the method as a battery cell case, as an electrode or as an electrode active material.

In a third aspect of the disclosure, there is provided a substrate in the form of an electrode or anode active material for use in a catalytic process comprising an aluminium oxide hydroxide coated on the substrate, wherein the aluminium oxide hydroxide has a particle size of about 10 to about 20 nm.

### BRIEF DESCRIPTION OF THE FIGURES

Embodiments of the disclosure will now be described with reference to the accompanying drawings which are not drawn to scale and which are exemplary only and in which:

FIG. 1: A process flow chart of a method for producing an aluminium oxide hydroxide-coated substrate according to an embodiment of the disclosure.

FIG. 2: A schematic of a method for producing an aluminium oxide hydroxide-coated substrate according to an embodiment of the disclosure.

FIG. 3: A process flow chart of a method for producing an aluminium oxide hydroxide-coated substrate according to embodiment of the disclosure.

FIG. 4: A schematic of a method for producing an aluminium oxide hydroxide-coated substrate according to embodiment of the disclosure.

FIGS. 5A-5B: FIG. 5A is an SEM image of uncoated graphite particles. FIG. 5B is an SEM image of aluminium oxide hydroxide-coated graphite particles according to an embodiment of the disclosure. The scale bars are 1 μm.

FIGS. 6A-6D: FIG. 6A is an image of an uncoated aluminium sheet. FIG. 6B is an image of an aluminium oxide hydroxide-coated aluminium sheet according to an embodiment of the disclosure. FIG. 6C is an SEM image of uncoated aluminium sheet. FIG. 6D is an SEM image of an aluminium oxide hydroxide-coated aluminium sheet according to an embodiment of the disclosure. The scale bars for FIGS. 6A and 6B are 1 cm. The scale bars for FIGS. 6C and 6C are 1 μm.

### DETAILED DESCRIPTION

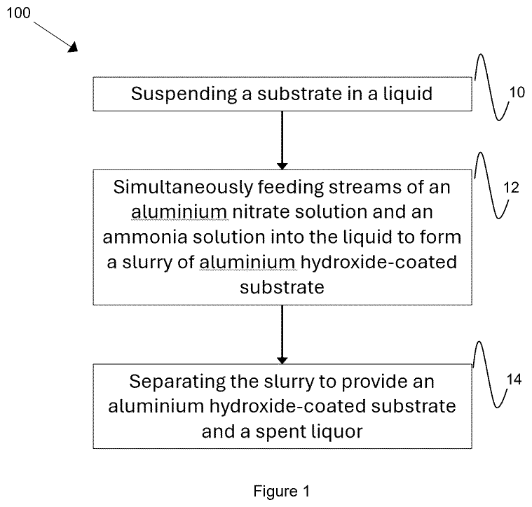

In FIG. 1, a process flow chart 100 of a method for producing an aluminium oxide hydroxide-coated substrate according to an embodiment of the disclosure is illustrated. At Step 10, a substrate is suspended in a liquid. At Step 12, streams of an aluminium nitrate solution and an ammonia solution are simultaneously fed into the liquid to form a slurry of aluminium oxide hydroxide-coated substrate. At Step 14, the slurry is separated to provide an aluminium oxide hydroxide-coated substrate and a spent liquor.

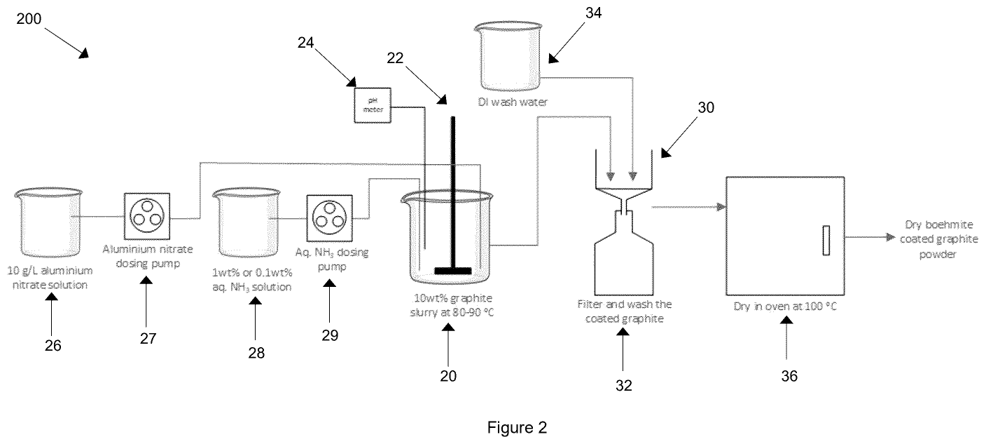

In FIG. 2, a schematic 200 of a method for producing an aluminium oxide hydroxide-coated substrate according to an embodiment of the disclosure is illustrated.

A reaction vessel 20 is filled with de-ionised water and placed in a hot water bath having a temperature of at least 80° C. An overhead agitator 22 is positioned above the reaction vessel 20 so that the blade sits above the bottom of the vessel and below the surface of the de-ionised water. An end of a pH probe 24 is immersed in the deionised water. A seed material is weighed into the reaction vessel 20.

A measured dose of aluminium nitrate solution is pumped from container 26 to the reaction vessel 20 by a peristaltic pump 27. A measured dose of ammonia solution is pumped from container 28 to the reaction vessel 20 by a peristaltic pump 29.

Once the reaction is complete, i.e. the aluminium nitrate is fully dispensed, and the slurry cooled, the slurry is filtered to separate the aluminium oxide hydroxide-coated seed material from the spent liquor.

The slurry is filtered through paper filters positioned in a Buchner funnel 30 into a vacuum flask 32. The filter cake which comprises the aluminium oxide hydroxide-coated seed material is then washed with de-ionised water 34. The washed filter cake is dried in an oven 36 at 100° C. to provide aluminium oxide hydroxide-coated particulate material.

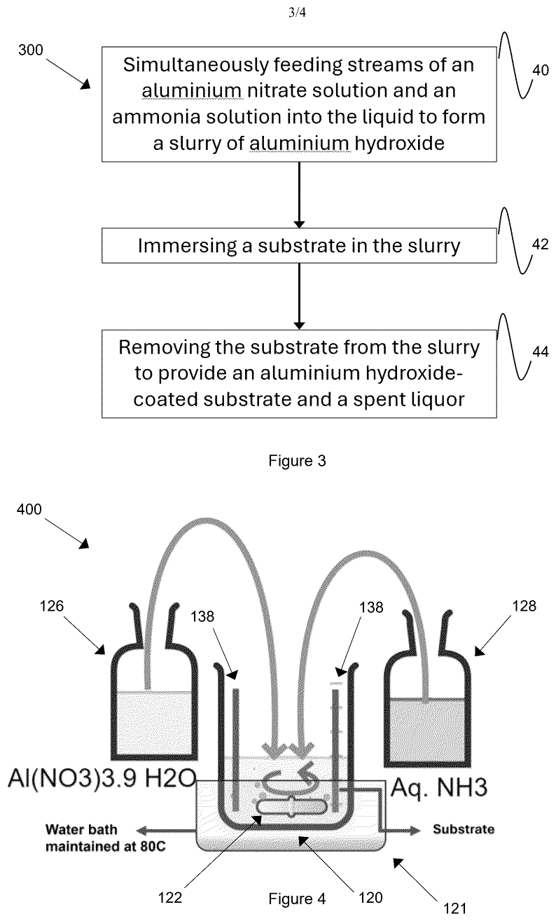

In FIG. 3, a process flow chart 300 of a method for producing an aluminium oxide hydroxide-coated substrate according to an embodiment of the disclosure is illustrated. At Step 40, streams of an aluminium nitrate solution and an ammonia solution are simultaneously fed into a liquid to form a slurry of aluminium oxide hydroxide. At Step 42, a substrate is immersed in the slurry. At Step 44, the substrate is removed from the slurry to provide an aluminium oxide hydroxide-coated substrate and a spent liquor.

In FIG. 4, a schematic 400 of a method for producing an aluminium oxide hydroxide-coated substrate according to an embodiment of the disclosure is illustrated.

A reaction vessel 120 is filled with de-ionised water and placed in a hot water bath 121 having a temperature of at least 80° C. magnetic stirrer 122 is positioned in the bottom of the vessel and below the surface of the de-ionised water.

A measured dose of aluminium nitrate solution is pumped from container 126 to the reaction vessel 120 by a peristaltic pump. A measured dose of ammonia solution is pumped from container 128 to the reaction vessel 120 by a peristaltic pump.

Metal plates 138 are immersed in the slurry to enable the crystallisation of the aluminium oxide hydroxide on the desired portion of the plate.

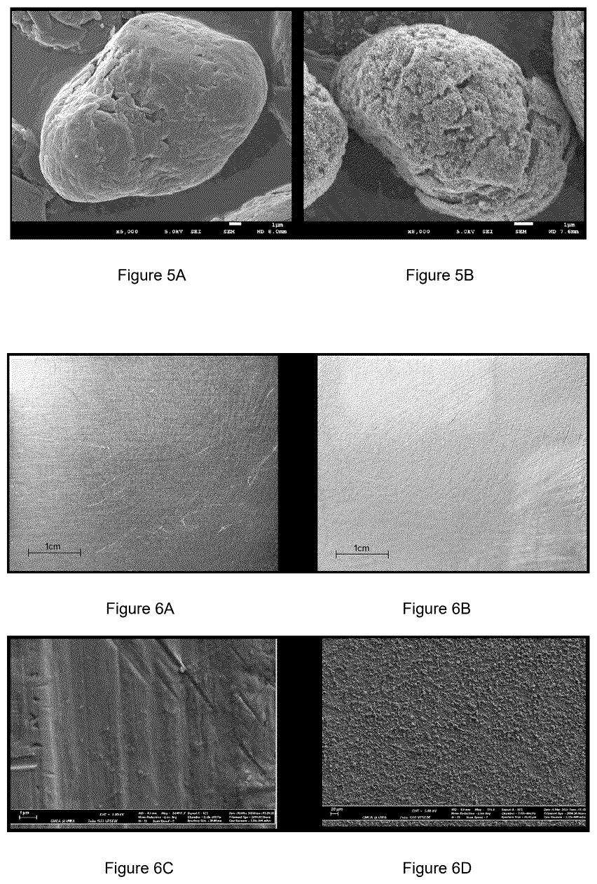

In FIG. 5, Scanning Electron Microscope (SEM) micrographs of uncoated graphite particles (FIG. 5A) and aluminium oxide hydroxide-coated graphite particles (FIG. 5B) are illustrated.

In FIG. 6, photographs of a surface of an uncoated aluminium sheet (FIG. 6A) and an aluminium oxide hydroxide-coated aluminium sheet (FIG. 6B). SEM micrographs of a surface of an uncoated aluminium sheet and an aluminium oxide hydroxide-coated aluminium sheet are illustrated in FIGS. 6C and 6D respectively.

### EXAMPLES

An example of an embodiment of the disclosure will now be described which is exemplary only and not limiting.

### Example 1

A 10 L beaker was filled with about 1,350 mL of de-ionised water and placed in a hot water bath having a temperature of at least 80° C. An overhead agitator was positioned above the beaker so that the blade sits above the bottom of the beaker and below the surface of the de-ionised water.

About 150 g of graphite with a BET surface area of 3.9 m²/g and a d50 of 15.1 μm was added to the beaker with stirring to suspend the graphite in the de-ionised water. The suspension comprises about 10% solids.

After the suspension reaches a temperature of about 80° C., aluminium nitrate and ammonia solution were added separately to the suspension substantially simultaneously to form a slurry of aluminium oxide hydroxide particles. About 554 mL of 10 g/L aluminium nitrate was dosed at a rate of about 2.3 mL/minute into the suspension over a period of about 4 hours. About 377 g of 0.2 wt % ammonia is dosed at a rate of about 1.6 mL/minute into the suspension over a period of about 4 hours.

The dose rate of ammonia may be adjusted to maintain the pH of the suspension at about 4.9 to about 5.1.

Once the reaction was complete, i.e. the aluminium nitrate is fully dispensed, the slurry was maintained at a temperature of about 80° C. and a pH of about pH of about 6.0 for 30 minutes with stirring. The slurry was allowed to cool to at least about 60° C.

The slurry was then filtered through two paper filters on a Buchner funnel under vacuum to separate the aluminium oxide hydroxide-coated graphite particles from the spent liquor. The filter cake (the aluminium oxide hydroxide-coated graphite particles) was removed from the paper and washed with 3:1 volume displacements of water. The washed wet cake is then dried at a temperature of about 300° C. over a period of about 12 hours.

### Example 2

Washed and dried aluminium oxide hydroxide-coated graphite particles may be calcined under reducing conditions (usually a nitrogen atmosphere) at a temperature of about 600° C. to about 900° C. to provide aluminium oxide-coated graphite particles. The ramp rate was about 2° C./minute, with a holding temperature of about 900° C. for a hold period of about 1 hour. The calcined substrate was then cooled in a nitrogen environment with a cooling rate about 2° C./minute.

The aluminium oxide-coated graphite particles have a target coating of about 0.50 wt %.

### Example 3

Metal plates were pretreated prior to coating to enhance the surface area and offer better reactive sites for the coating material. The pretreatment included immersing the stainless steel plate in an aqueous solution of ammonia at a concentration of 0.2 wt % and subjecting it to sonication for 1 minute. Subsequently, the stainless steel plate was rinsed with deionized water before being dried in an oven at 50° C. An aluminium plate was pretreated by immersing the plate in isopropyl alcohol and subjecting the plate to sonication for 1 minute. Afterwards, the aluminium plate was dried in an oven at 50° C.

A 10 L beaker was filled with about 1,350 mL of de-ionised water and placed in a hot water bath having a temperature of at least 80° C. An overhead agitator was positioned above the beaker so that the blade sits above the bottom of the beaker and below the surface of the de-ionised water. (Alternatively, a magnetic stirrer bar could have been used to agitate the reaction mixture.)

After the de-ionised water reached a temperature of about 80° C., aluminium nitrate and ammonia solution are added separately to the suspension substantially simultaneously to form a slurry of aluminium oxide hydroxide particles. About 554 mL of 10 g/L aluminium nitrate was dosed at a rate of about 2.3 mL/minute into the slurry over a period of about 4 hours. About 377 g of 0.2 wt % ammonia was dosed at a rate of about 1.6 mL/minute into the slurry over a period of about 4 hours.

The dose rate of ammonia was adjusted to maintain the pH of the slurry at about 4.9 to about 5.1.

After ample reaction volume was attained in the reaction vessel and the pH had been stabilised to about 4.9 to 5.1, the metal plate was immersed in the slurry to enable the crystallisation of the aluminium oxide hydroxide on the desired portion of the plate. The metal plate was immersed in the slurry to coat the plate.

Once the desired coating was achieved, the coated metal plate remained immersed in the slurry at a temperature of about 80° C. and a pH of about pH of about 6.0 for 30 minutes with stirring.

The metal plate was removed from the slurry and rinsed with de-ionised water. The metal plate was dried in an oven at a temperature of about 50° C.

It is to be understood that, if any prior art publication is referred to herein, such reference does not constitute an admission that the publication forms a part of the common general knowledge in the art, in Australia or any other country.

In the claims which follow and in the preceding description of the disclosure, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the disclosure.

Any promises made in the present description should be understood to relate to some embodiments of the disclosure and are not intended to be promises made about the disclosure as a whole. Where there are promises that are deemed to apply to all embodiments of the disclosure, the applicant/patentee reserves the right to later delete them from the description and does not rely on these promises for the acceptance or subsequent grant of a patent in any country.

1. A method for producing a coated substrate, the method comprising:
forming an aluminium oxide hydroxide slurry by simultaneously feeding streams of an aluminium nitrate solution and a basic solution such as an ammonia solution into a liquid over a reaction period, while maintaining an elevated temperature and a controlled pH;
allowing a substrate to contact the slurry to thereby form an aluminium oxide hydroxide coating on the substrate; and
separating the coated substrate from the liquid.

2. The method of claim 1, wherein the substrate is a particulate material comprising one or more of silicon powder, graphite powder, and a metal oxide.

3. The method of claims 1, wherein the substrate is a plate.

4. The method of claim 1, wherein the substrate is an electrode selected from a metal electrode or an anode active material.

5. The method of claim 1, wherein the elevated temperature is about 60° C. to about 100° C., such as about 80° C.

6. The method of claim 1, wherein the pH is controlled to be within the range of about 4.5 to about 5.5 such as about 4.9 to about 5.1.

7. The method of claim 1, wherein the substrate is added to the slurry before the reaction period.

8. The method of claim 1, wherein the substrate is added to the slurry after the reaction period.

9. The method of claim 1, wherein the substrate is immersed in the slurry after the slurry reaches a stable pH range of about 4.5 to about 5.5.

10. The method of claim 1, wherein after the reaction period, the slurry is held at a temperature of about 60° C. to about 100° C., such as 80° C., and the pH is about 5.5 to about 6.5, such as about 6.0.

11. The method of claim 10, wherein the after the reaction period, the slurry is held at the temperature and pH for about 30 minutes.

12. The method of claim 1, wherein the pH of the slurry is adjusted to provide an aluminium oxide hydroxide monohydrate coating.

13. The method of claim 1, wherein the pH of the slurry is adjusted to a provide an aluminium oxide hydroxide trihydrate coating.

14. The method of claim 1, further comprising cooling the slurry e.g. to a temperature of about 60° C. before separating the coated substrate from the liquid.

15. The method of claim 1, wherein the coated substrate is particulate and is separated from the spent liquor by filtration.

16. The method of claim 1, wherein the coated substrate is dried at a temperature of up to about 300° C. for about 12 hours after separation from the spent liquor.

17. The method of claim 16, further comprising calcining the coated substrate under reducing conditions.

18. The method of claim 17, wherein the aluminium oxide hydroxide-coated substrate is calcined at a temperature of about 600° C. to 900° C. under an inert atmosphere.

19. The method of claim 1, wherein the duration of the reaction period is controlled or the concentration of the aluminium nitrate solution and a basic solution are adjusted to increase the thickness of the coating.

20. The method according to claim 1, further comprising pre-treating the substrate to optimise the active sites for coating reaction.
